(19) United States
(12) Patent Application Publication
(10) Pub. No.: US 2005/0028875 A1
(43) Pub. Date: Feb. 10, 2005

(54) Control unit for inflatable devices

(76) Inventors: David EdmundTalbot German, Powys (GB); Simon Christopher Jackson, Hants (GB)

Correspondence Address: NOTARO AND MICHALOS, 100 DUTCH HILL ROAD, SUITE 110, ORANGEBURG, NY, 10962-2100, US

(21) Appl. No.: 10/746,332

(22) Filed: Dec. 23, 2003

(30) Foreign Application Priority Data
Aug. 8, 2003 (GB) 0318675.6

(51) Int. Cl. F16K 11/20

(52) U.S. Cl. 137/596

(57) ABSTRACT

This invention relates to a control unit for controlling the supply of compressed air to a plurality of inflatable devices in order to inflate them individually, and the venting of air from the devices in order to deflate them. The unit comprises a plurality of valves operable directly by respective finger operable devices. The valves are arranged in two groups. The valves of one group are operatively disposed between an inlet connected, or connectible to, a source of compressed air and a corresponding number of individual parts connected, or connectible to, the respective devices, whereas the valves of the other of said groups is operatively connected between a venting outlet and either of said parts or a corresponding number of further parts which are connected, or connectible to, the respective chambers. This invention further relates to an apparatus for lifting a person from the ground or floor, which comprises a plurality of inflatable bags configured to lift a person when one or more of the bags are inflated and lower the person when one or more of the bags is deflated. The inflation/deflation of individual bags is controlled by the control unit of the invention.

### TECHNICAL FIELD

This invention relates to a control unit for controlling the supply of compressed air to a plurality of inflatable devices in order to inflate them individually, and the venting of air from the devices in order to deflate them.

Such control units have many uses. The unit of the present invention has been devised primarily for use with apparatus for lifting a person who for some reason such as disability or frailty cannot raise himself or herself from the ground or floor, for example after falling, the apparatus comprising a plurality of inflatable air bags secured together in a stack and connected or connectible to a source of compressed air, and a control unit for controlling the flow of compressed air from said source to the individual air bags in order to raise a person supported by the stack to a height dependant on the number of air bags which are inflated.

Various forms of such apparatus are known which are adapted to operate at relatively low air pressures of up to 0.35 Bar (5 p.s.i.) (compared, for example, with the higher pressure required to operate power tools).

The object of the present invention is to provide an improved form of control unit for the purpose specified.

A particular aim of the invention is to provide an improved form of control unit which is suitable for use in an apparatus for lifting a person as described above, especially such an apparatus which is adapted to operate at relatively low air pressures of up to 0.35 Bar (5 p.s.i.) and is easily portable.

### DISCLOSURE OF THE INVENTION

According to the invention there is provided a hand-held control unit for controlling the supply of compressed air to a plurality of inflatable devices in order to inflate them, and the venting of air from the devices in order to deflate them, wherein the unit is provided with a plurality of valves operable directly by respective finger-operable devices, the valves being arranged in two groups, the valves of one group being operatively disposed between an inlet connected or connectible to a source of compressed air and a corresponding number of individual ports connected or connectible to the respective devices, and the valves of the other group being operatively connected between a venting outlet and either the said ports or a corresponding number of further ports which are connected or connectible to the respective chambers.

Preferably the finger-operable devices are push-buttons. Conveniently the devices of each group are disposed in a row which when the unit is placed In the palm of the hand, extends transversely with respect to the fingers whereby the devices can be operated by the fingers in the manner of a musical wind instrument.

Preferably the two groups of said devices are disposed on respectively opposite faces of the control unit so that by simply turning the unit in the palm of the hand through approximately 180° the group of devices to be operated can be changed.

Preferably the same ports are used for the supply of compressed air to the chambers and the venting of air from the chambers,

Each valve preferably comprises a valve element having a stem and a head which is arranged to co-operate with a valve seat, the associated push-button being arranged to act directly on said stem.

According to a second aspect of the invention, there is provided a hand-held control unit for controlling the supply of compressed air to a plurality of inflatable devices in order to inflate them, and the venting of air from the devices in order to deflate them, wherein the unit is provided with a plurality of finger-operable devices which are arranged in two groups, the finger-operable devices of one group being adapted, respectively, to control the supply of compressed air to the individual inflatable devices and the finger-operable devices of the other group being adapted, respectively, to control the venting of air from the individual inflatable devices, wherein the two groups of said devices are disposed on respectively opposite faces of the control unit so that by simply turning the unit in the palm of the hand through approximately 180° the group of devices to be operated by the fingers can be changed.

According to a further aspect of the invention there is provided apparatus for lifting a person from the ground or floor, the apparatus comprising a plurality of inflatable air bags secured together in a stack and connected or connectible to a source or compressed air, and a control unit for controlling the flow of compressed air from said source to the individual air bags in order to inflate them and the venting of air from the bags in order to deflate them, wherein the control unit is constructed in accordance with the first or second aspect of the invention,

The foregoing features of the invention will be more readily understood upon consideration of the following detailed description of the invention, taken in conjunction with the accompanying drawings.

### BRIEF DESCRIPTION OF THE DRAWINGS

FIG. 1 is a perspective view of an apparatus for lifting a person which incorporates a control unit according to the present invention,

FIG. 2 and FIG. 3 are diagrammatic representations showing the manner in which the apparatus of FIG. 1 is used,

FIG. 4 is a plan view of the control unit,

FIG. 5 is a longitudinal sectional view of the control unit taken on the line A-A in FIG. 4,

FIG. 6 is a cross sectional view taken on the line B-B in FIG. 4,

FIG. 7 is a cross sectional view taken on the line C-C in FIG. 4, and

FIG. 8 is an end view of the control unit taken in the direction of arrow D in FIG. 4.

### DETAILED DESCRIPTION

Referring to the drawings which form part of the disclosure herein, as shown in FIG. 1 an apparatus for use in lifting a person who cannot raise himself or herself from the floor, for example after falling, comprises an inflatable support 10, an air compressor 11 for producing a supply of pressurized air and a control unit 12 for controlling the flow of air from the compressor to the support in order to inflate it and venting of air from the support in order to deflate it.

The support 10 comprises four rectangular air bags 13 which are secured together in a stack. When inflated the bags are each of pillow-shape and when deflated the bags lie flat on the floor. Two bars 14 are attached to the lower bag to provide a rigid stable base for the support.

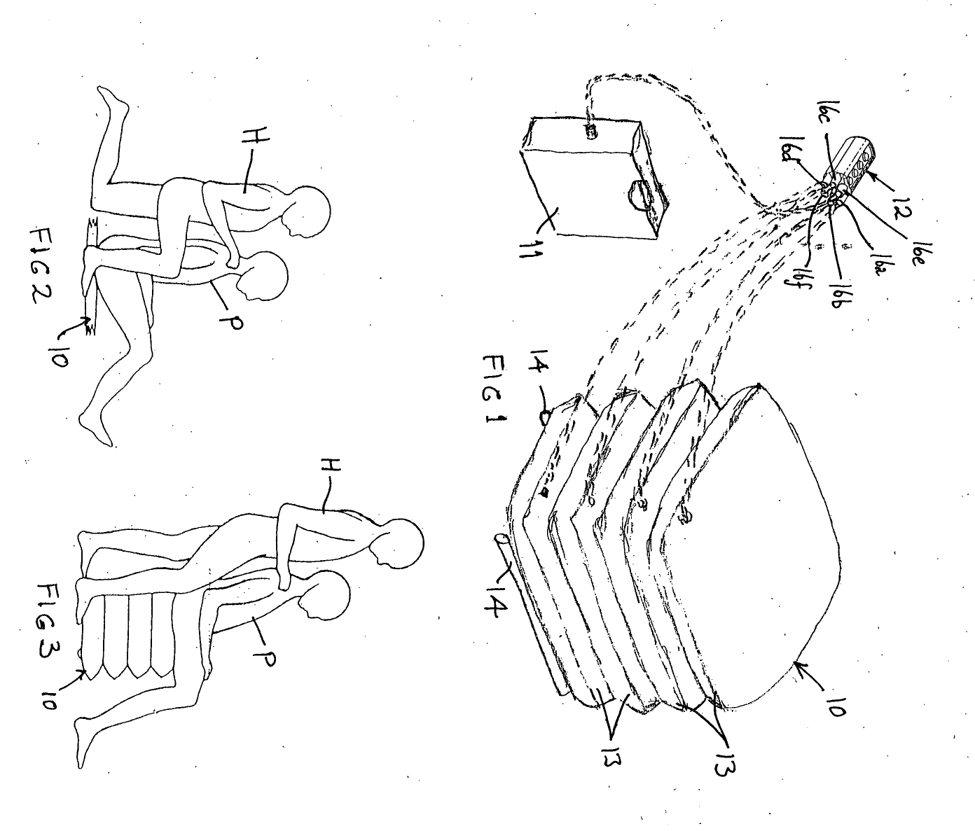

FIGS. 2 and 3 show the manner in which the apparatus is designed to be used. A person P who is required to be raised from the floor is helped by the operator H of the apparatus to move into an upright position sitting on the deflated support 10 (FIG. 2). The control unit 12 is then operated to cause compressed air to flow to the air bags 13 in order to inflate them and thereby raise the person P from the floor (FIG. 3). It is then easier for the person to stand up or be lifted into a wheelchair or on to a bed or chair. The control unit is then operated to vent the air bags 13 so that they can be flattened and folded for insertion into a carrying bag together with the bars 14.

The compressor 11 is portable and battery-powered. It is adapted to produce a supply of air at a pressure of up to 0.35 Bar (5 p.s.i.).

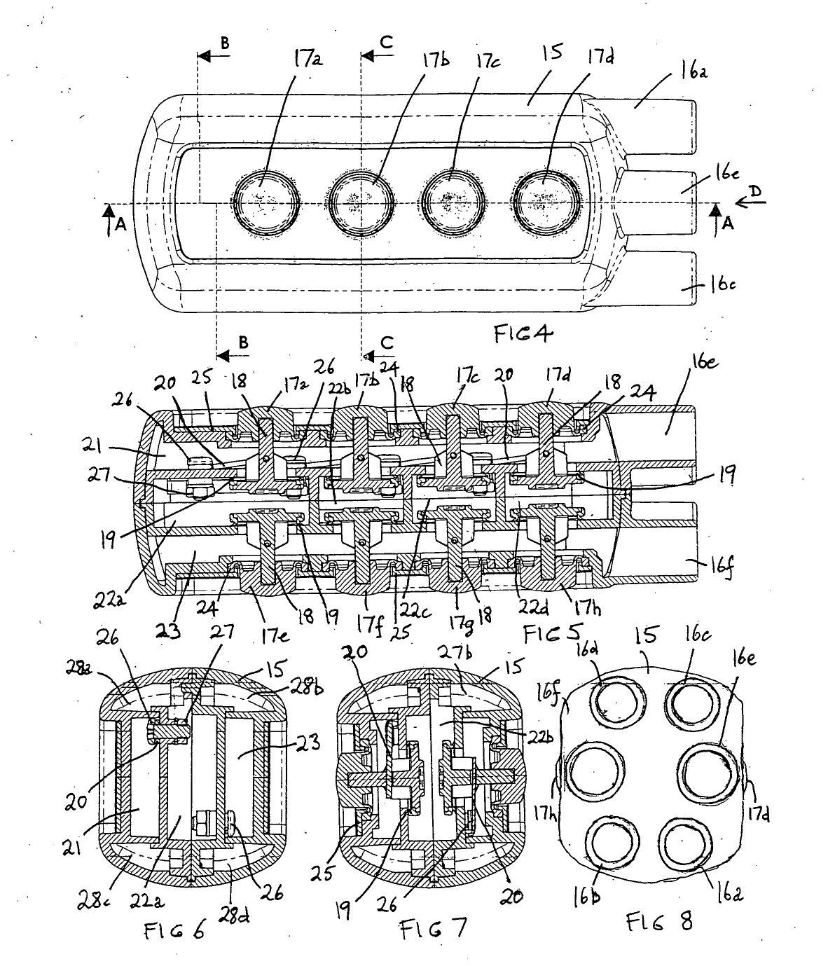

The control unit 12 which is constructed and designed in accordance with the present invention is shown in detail in FIGS. 4-7 and comprises an elongate housing 15 formed at one end with six ports 16a, 16b, 16c, 16d, 16e and 16f. Each port is defined by a hollow spigot projecting from the housing.

Two rows each of four finger-operable devices in the form of rubber push-buttons 17 are arranged along respectively opposite sides of the housing 15. The push-buttons marked 17a, 17b, 17c and 17d are arranged to control the supply of compressed air to the respective air bags 13 and the push-buttons marked 17e, 17f, 17g, and 17h are arranged to vent air from the respective air bags.

Each push-button 17 is recessed to receive one end of the stem of a poppet valve element 18, the opposite end having a head which is arranged to cooperate with a valve seat 19 formed in the housing. A spring 20 acts on each valve element to urge its head into engagement with its valve seat so that the valve is normally closed, the spring being attached to the housing by a screw 26 and a nut 27. The valve can be opened by moving the valve element axially against the action of the spring by depressing and deforming the push-button.

The valve seats 19 of the push-buttons 17a-17d are located between a chamber 21 formed in the housing in communication with port 16e which is an air inlet, and respective chambers 22a, 22b, 22c and 22d which communicate, respectively, with the ports 16a, 16b, 16c and 16d via channels 28a, 28b, 28c, and 28d. The valve seats of the push-buttons 17e-17h are located between the respective chambers 22a-22d and a chamber 23 which communicates with port 16f which is a venting outlet.

In order to open one of the valves associated with the push-buttons 17a-17d to allow compressed air to flow to the corresponding air bag, or one of the valves associated with the push-buttons 17e-17h to vent the corresponding air bag, the corresponding push-button is simply depressed to move its valve element against the action of the associated spring 20. As the apparatus operates at low air pressure, there is negligible resistance to operation of the push-buttons.

The push-buttons 17 are each formed at its inner end with an outwardly projecting lip 24 which engages behind a plate 25 to hold the button in place, the button extending through an aperture in the plate.

The provision of separate push-buttons for inflating and venting the air bags individually firstly enables the support 10 to be expanded and contracted gradually, the air bags being fully inflated and completely deflated one at a time by depressing the push-buttons 17a-17d and 17e-17h one at a time in succession. Each bag has to be fully inflated to a stable condition before inflation of the next bag commences, Secondly the number of air bags which are inflated can be varied so as to vary the height to which the support is expanded and hence the distance a person is raised from the ground or floor.

The arrangement of the push-buttons 17 in rows enables them, with the unit held in the palm of the hand, to be operated in the manner of the keys of a musical wind instrument. Also, the arrangement of the rows on opposite sides of the control unit enables the two sets of push buttons to be brought into and out of their in-use positions simply by turning the unit in the palm of the hand through 180°.

1. A hand-held control unit for controlling the supply of compressed air to a plurality of inflatable devices in order to inflate them, and the venting of air from the devices in order to deflate them, wherein the unit is provided with a plurality of valves operable directly by respective finger-operable devices, the valves being arranged in two groups, the valves of one group being operatively disposed between an inlet connected or connectable to a source of compressed air and a corresponding number of individual pots connected or connectible to the respective devices, and the valves of the other group being operatively connected between a venting outlet and either the said ports or a corresponding number of further ports which are connected or connectible to the respective chambers.

2. The control unit of claim 1 wherein the finger-operable devices are push-buttons.

3. The control unit of claim 2 wherein the devices of each group are disposed in a row which when the unit is placed in the palm of the hand, extends transversely with respect to the fingers whereby the devices can be operated by the fingers in the manner of a musical wind instrument.

4. The control unit of any one of claims 1 wherein the two groups of said devices are disposed on respectively opposite faces of the control unit so that by simply turning the unit in the palm of the hand through approximately 180° the group of devices to be operated can be changed.

5. The control unit of any of claims 1 wherein the same ports are used for the supply of compressed air to the chambers and the venting of air from the chambers.

6. The control unit of any of claims 1 wherein each valve preferably comprises a valve element having a stem and a head which is arranged to co-operate with a valve seat, the associated push-button being arranged to act directly on said stem.

7. A hand-held control unit for controlling the supply of compressed air to a plurality of inflatable devices in order to inflate them, and the venting of air from the devices in order to deflate them, wherein the unit is provided with a plurality of finger-operable devices which are arranged in two groups, the finger-operable devices of one group being adapted, respectively, to control the supply of compressed air to the individual inflatable devices and the finger-operable devices of the other group being adapted, respectively, to control the venting of air from the individual inflatable devices, wherein the two groups of said devices are disposed on respectively opposite faces of the control unit so that by simply turning the unit in the palm of the hand through approximately 180° the group of devices to be operated by the fingers can be changed.

8. Apparatus for lifting a person from the ground or floor, the apparatus comprising a plurality of inflatable air bags secured together in a stack and connected or connectible to a source or compressed air, and a control unit for controlling the flow of compressed air from said source to the individual air bags in order to inflate them and the venting of air from the bags in order to deflate them, wherein the control unit is constructed in accordance with claim 1.
